(19) United States
(12) Patent Application Publication
(10) Pub. No.: US 2024/0250804 A1
(43) Pub. Date: Jul. 25, 2024

(54) QUANTUM RESISTANT ENCRYPTION SYSTEM AND METHOD OF USE THEREOF

(71) Applicant: VeriTX Corp., Buffalo, NY (US)

(72) Inventor: James Allen Regenor, East Aurora, NY (US)

(21) Appl. No.: 18/156,708

(22) Filed: Jan. 19, 2023

(51) Int. Cl. H04L 9/08

(52) U.S. Cl. CPC H04L 9/0822

(57) ABSTRACT

A method for encrypting a digital data file includes selecting a set of two or more random algorithms to form an encryption key file and synchronizing the encryption key file between a sending node and a receiving node over a network. The digital data file is encrypted to include the encryption key file and is sent from the sending node to the receiving node. The receiving node decrypts the encrypted digital data file using the encryption key file. Each of the two or more random algorithms are quantum resistant encryption algorithms and each is selected for a respective random length of time so that each respective length of time is a portion of the encryption key file. The sending node and the receiving node are synchronized to a global positioning system clock or via a point-to-point communication.

### FIELD OF THE INVENTION

The present invention broadly relates to data encryption and more particularly relates to a system and method employing a quantum resistant algorithm library synchronized with a clock data file for hopping between algorithms to create an infinite set of encryption keys assigned to a data set.

### BACKGROUND OF THE INVENTION

Data security is of utmost importance to individuals, organizations and governments operating in a Web3 or other digital environment. To date, most digital security is based on maintaining security policies, privacy of usernames, and passwords. Should hackers breach username and password security measures, those hackers gain access to potentially all of the data files associated with that username account. Another approach is to not only protect user identity and access, but also to provide for data security of the data sets by securing encrypted data files through randomized algorithm hopping to confound possible nefarious decryption of the data by a non-approved receiver of the data or a data hacker so that any breach of the account does not result in capture of useful digital files.

### SUMMARY OF THE INVENTION

The present invention provides a system and method for quantum resistant algorithm hopping encryption that requires nodes to synchronize their timing for algorithm hopping, for example, via a common encryption file (a “common Mickey”) such as from the current GPS clock or direct from sender to receiver for a more secure and direct method. Leveraging a library of quantum resistant algorithms, random algorithms may be selected and then synchronized to create a unique encryption set for data being transmitted within an ad hoc network of nodes or direct point to point. The duration of each algorithm operation may also be synchronized for further encryption. This will create an infinite set of potential outcomes that will require tremendous computing power to break.

In an embodiment, a method for encrypting a digital data file comprises: a) selecting a set of two or more random algorithms to form an encryption key file; b) synchronizing the encryption key file between a sending node and a receiving node over a network; c) encrypting the digital data file to include the encryption key file; and d) sending the encrypted digital data file from the sending node to the receiving node. The receiving node decrypts the encrypted digital data file using the encryption key file.

In a further aspect of an embodiment of the present invention, each of the two or more random algorithms are quantum resistant encryption algorithms. Each of the two or more random algorithms may also be selected for a respective random length of time wherein each respective length of time comprises a portion of the encryption key file. The sending node and the receiving node may be synchronized to a global positioning system (GPS) clock or via a point-to-point communication.

Additional objects, advantages and novel aspects of the present invention will be set forth in part in the description which follows, and will in part become apparent to those in the practice of the invention, when considered with the attached figure.

### DESCRIPTION OF THE DRAWING FIGURES

The above-mentioned and other features and advantages of this invention, and the manner of attaining them, will become apparent and be better understood by reference to the following description of the invention in conjunction with the accompanying drawing, wherein:

FIG. 1 is a simplified schematic view of an exemplary embodiment of a system configured for encrypting a digital data file in accordance with an aspect of the invention;

FIG. 2 is a flowchart showing an exemplary embodiment of a workflow algorithm for a method of encrypting a digital data file in accordance with an aspect of the invention;

FIG. 3 is a flowchart showing an exemplary embodiment of a workflow algorithm for a method of decrypting a digital data file in accordance with an aspect of the invention;

FIG. 4A is a schematic representation of an exemplary generation of an encryption key file in accordance with an aspect of the invention; and

FIG. 4B is a schematic representation of another exemplary generation of a further encryption key file in accordance with an aspect of the invention.

### DETAILED DESCRIPTION OF A PREFERRED EMBODIMENT

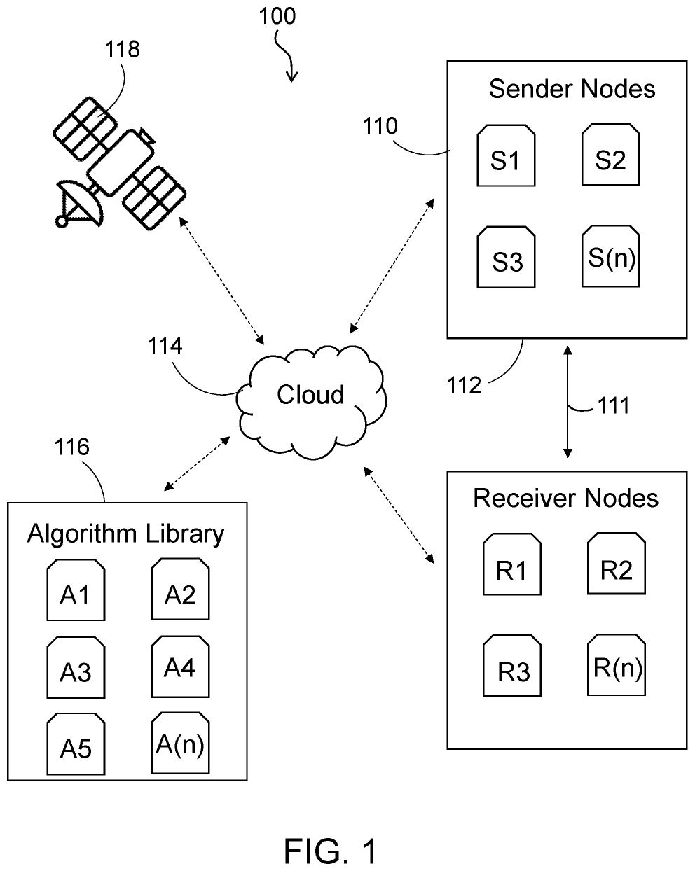

Turning now to the figures, FIG. 1 shows a generalized schematic view of a non-limiting networked computing system 100 configured to encrypt and share digital data files in accordance with an exemplary embodiment of the invention. Networked computing system 100 may be decentralized and may generally include a one or more sender nodes 110 (e.g. respective sender nodes S1, S2, S3 . . . S(n)), and one or more receiver nodes 112 (e.g. respective receiver nodes R1, R2, R3 . . . R(n)) communicatively networked together, such as through the internet or cloud 114. Files may be transferred from any one or more sender nodes 110 to any one or more receiver nodes 112 via cloud 114. Alternatively, any one or more sender nodes 110 may be directly communicatively coupled to any one or more receiver nodes 112, such as through a local area network (LAN), Bluetooth or hardwire connection 111. It should be understood that sender nodes 110 and receiver nodes 112 may comprise any computing device having a memory and processor and may be configured to operate software to implement the methods and processes described herein. Non-limiting examples of computing systems include, but are not limited to, personal computers, laptops, tablets, smartphones and the like.

As further shown in FIG. 1, an algorithm library 116 may be communicatively coupled to cloud 114 and accessible by sender nodes 110 and receiver nodes 112. Algorithm library 116 may be a database or other network accessible storage location having a plurality of encryption algorithms A1-A(n) stored therein. In one aspect of the invention, encryption algorithms A1-A(n) are quantum-resistant cryptic algorithms, such as and without limitation thereto, those quantum resistant cryptic algorithms adopted and/or standardized by the United States National Institute of Standards and Technology (NIST) and/or other international standardization agencies.

In one aspect of the invention and as will be described in more detail below, data file transfer requires synchronization between one or more sender node(s) 110 to one or more desired receiver node(s) 112. Synchronization may utilize clock synchronization, such as via a GPS clock 118 within the GPS clock satellite system. Alternatively, sender/receiver nodes that are directly coupled to one another, may synchronize through reconciliation between each node's internal clock without utilizing GPS clock 118.

As described in greater detail below, a method of transferring a data file may include selecting a data file at a sender computing system (e.g., a sender node 110) and encrypting the selected data file by using two or more random encryption algorithms from algorithm library 116. In an embodiment, the encrypting and transferring of the data file may be implemented over networked system 100 described above. As such reference may be made to reference numbers of FIG. 1 in the following description. It should be recognized by those in the art that alternative systems may also be suitable to implement the method, such that the method may be modified so as to be implemented on these alternative systems. In a further embodiment and as will be described in greater detail below, the encrypted data file may be received at one or more receiver node(s) 112 and decrypted only if the sender and receiver node(s) 110/112 were synchronized during the encryption.

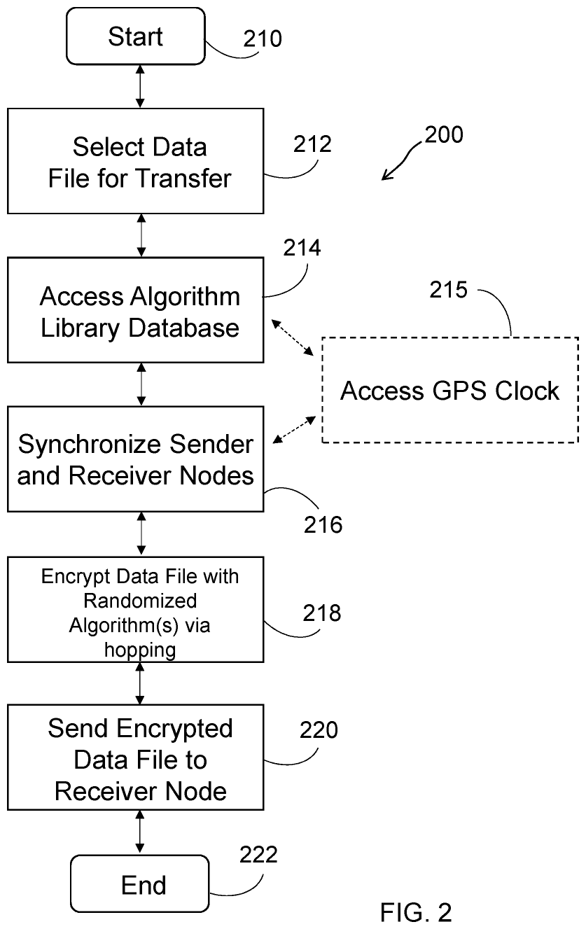

Turning now to FIG. 2, a method 200 for encrypting and transferring a data file generally starts at 210 and includes at 212 a user at a sender node 110 (e.g., one or more of nodes S1-S(n)) selecting a data file for transfer. In an embodiment, multiple data files may be selected and may be processed as described herein either in series or in parallel to transfer the multiple data files from sender node 110 to a selected one or more receiver node(s) 112. Once the data file has been selected at 212, sender node 110 accesses algorithm library 116 through the cloud 114 at 214 and synchronizes with receiver node(s) 112 at 216. It should be noted that steps 214 and 216 can occur in either order. If communicating over internet/cloud 114, sender node(s) 110 and receiver node(s) 112 may be synchronized through communicatively engaging with GPS clock 118 at 215.

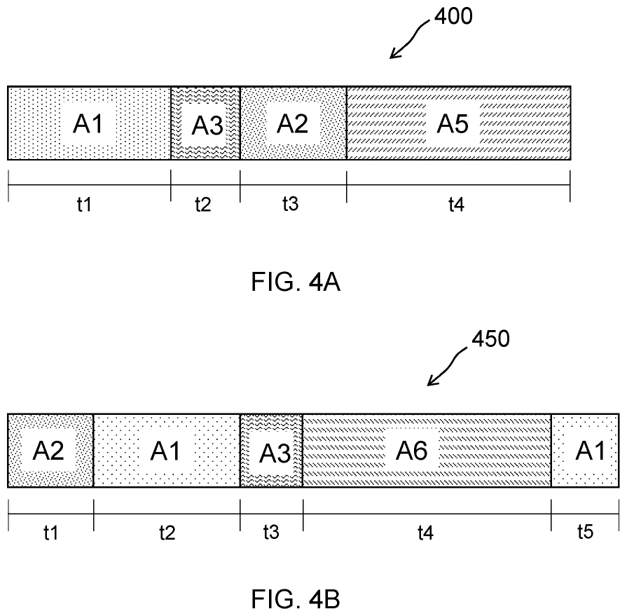

Once synchronized, the selected data file is encrypted via two or more encryption algorithms from algorithm library 116 at 218. In one embodiment, the identity of each encryption algorithm is randomized. In a further embodiment, the length of time each algorithm is employed in encrypting the data file is randomized. For instance and without limitation thereto, FIG. 4A shows a schematic representation of an exemplary generation of an encryption key file 400. As shown, encryption key file 400 consists of a random order of encryption algorithms, namely A1:A3:A2:A5. Moreover, the timing of the algorithm switching or hopping has also been randomized. For instance, algorithm A1 operates for a time period t1 while algorithm A3 operates for time period t2 (and A2 for t3 and A5 for t4). Similar, FIG. 4B shows a schematic representation of an exemplary generation of an encryption key file 450 consisting of algorithm A2 (for t1):A1 (for t2):A3 (for t3):A6 (for t4):and A1 (again, for t5). As such, encryption of the data file leverages not only the encryption offered by a single quantum resistant encryption algorithm, but infinitely expands the encryption power through the combined randomization of algorithm identity and timing to result in the generation of an infinite number of encryption key files that are highly unhackable or uncompromisable even using the processing power of a quantum computer. Once encrypted, the encrypted data file is transferred to receiver node(s) 112 at 220 before stopping method 200 at 222.

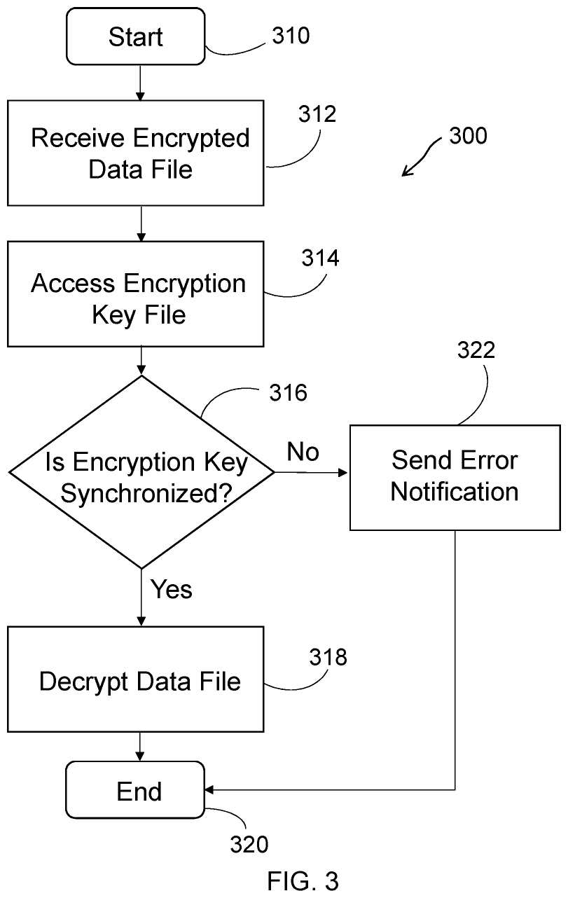

With reference to FIG. 3, in an exemplary embodiment of the present invention, software operating on one or more receiving node(s) 112 may be configured to perform method 300 for decrypting the encrypted data file transferred thereto via method 200 described above with regard to FIG. 2. By way of example and without limitation thereto, method 300 may start at 310 and continue at 312 wherein the encrypted data file and encryption key file sent from the sender node(s) 110 (e.g., at step 220 of FIG. 2) are received at receiver node(s) 112.

After receiving the encrypted data file and encryption key file, the software operating on one or more receiving node(s) 112 may then access the encryption key file at 314 whereby the processor of the receiving node(s) 112 compares the encryption key file within the encrypted data file to the encryption key file stored in the memory of the receiving node(s) 112 to ensure synchronization between the sender and receiver node(s) 110/112 at 316. If the encryption key files are properly synchronized, the processor of the receiving node(s) 112 may then properly decrypt the encrypted data file at 318 to render the selected data file and stop at 320. Alternatively, if the encryption key files are not synchronized, the processor of the receiving node(s) 112 decrypts the encrypted data file at 322 to render a nonsensical data file and/or issues an error notification to either or both of the users of sender node(s) 110 and receiving node(s) 112 advising the user(s) that the data file transfer was not successful before stopping at 320.

While the apparatus, methods and systems have been shown and described with reference to certain preferred embodiments thereof, it will be understood by those skilled in the art that various changes in form and details may be made therein without departing from the spirit and scope of the invention as defined by the claims which follow.

What is claimed is:

1. A method for encrypting a digital data file comprising:
a) selecting a set of two or more random algorithms to form an encryption key file;
b) synchronizing the encryption key file between a sending node and a receiving node over a network;
c) encrypting the digital data file to include the encryption key file;
d) sending the encrypted digital data file from the sending node to the receiving node, wherein the receiving node decrypts the encrypted digital data file using the encryption key file.

2. The method in accordance with claim 1 wherein the encryption key file is generated through synchronized algorithm hopping and variable time durations.

3. The method in accordance with claim 1 wherein each of the two or more random algorithms are quantum resistant encryption algorithms.

4. The method in accordance with claim 1 wherein each of the two or more random algorithms are selected for a respective random length of time wherein each respective length of time comprises a portion of the encryption key file.

5. The method in accordance with claim 1 wherein the sending node and the receiving node are synchronized to a global positioning system (GPS) clock.

6. The method in accordance with claim 1 wherein the sending node and the receiving node are synchronized via a point-to-point communication.
